(19) United States
(12) Patent Application Publication
(10) Pub. No.: US 2011/0116417 A1
(43) Pub. Date: May 19, 2011

(54) METHOD AND APPARATUS FOR DETERMINING PING INTERVAL OF ACTIVESYNC SERVICE IN WIRELESS COMMUNICATION TERMINAL

(75) Inventor: Yo-Han CHANG, Suwon-si (KR)

(73) Assignee: SAMSUNG ELECTRONICS CO. LTD., Suwon-si (KR)

(21) Appl. No.: 12/939,488

(22) Filed: Nov. 4, 2010

(30) Foreign Application Priority Data
Nov. 16, 2009 (KR) 10-2009-0110341

(51) Int. Cl. H04L 12/28

(52) U.S. Cl. 370/255

(57) ABSTRACT

A method and an apparatus for determining a Packet INternet Groper (PING) interval of an ActiveSync service in a wireless communication terminal are provided. The method includes determining an initial PING interval of a first account among the plurality of accounts, and determining PING intervals of the remaining accounts, with the exception of the first account, as an integer multiple of the initial PING interval.

### PRIORITY

This application claims the benefit under 35 U.S.C. §119(a) of a Korean patent application filed in the Korean Intellectual Property Office on Nov. 16, 2009, and assigned Serial No.10-2009-0110341, the entire disclosure of which is hereby incorporated by reference.

### BACKGROUND OF THE INVENTION

1. Field of the Invention:

The present invention relates to a method and an apparatus for determining a Packet INternet Groper (PING) interval of an ActiveSync service in a wireless communication terminal. More particularly, the present invention relates to a method and an apparatus for determining a PING interval for a plurality of accounts in a wireless communication terminal using an ActiveSync protocol.

2. Description of the Related Art:

ActiveSync protocol, which is a protocol developed for synchronizing data such as an electronic mail (e-mail) and the like between an active server and a client, operates in three modes. The three modes of the ActiveSync protocol are given as follows:

Manual mode for performing synchronization according to a user's request;

Scheduled mode for performing synchronization at time interval's preset by a user; and

Push mode for performing synchronization in a case where there is a change in the active server or client.

The push mode may require that the client transmits a message, called a PING, to the active server at a constant interval and thus monitors for a change of the active server during a duration included in the PING message. Such a system has no particular problem in the wired environment, but causes various problems in the wireless communication environment.

FIG. 1 is a ladder diagram illustrating a PING message transmission procedure of a wireless communication Mobile Station (MS) according to the related art.

Referring to FIG. 1, in step 110, the wireless communication MS 100 establishes a Radio Resource Control (RRC) connection with a mail server 102 to transmit a PING message to the mail server 102. After the RRC connection is established, in step 112, the wireless communication MS 100 transmits the PING message to the mail server 102. In step 114, the wireless communication MS 100 releases the RRC connection with the mail server 102.

In the above described method, there is a disadvantage in the wireless communication environment where, whenever transmitting a PING message, the wireless communication MS needs to perform an operation of forming/releasing a channel for data communication with a network. In addition, there is a problem in that current consumption increases during a time for which the channel is formed because a Radio Frequency (RF) device of the wireless communication MS is operated at the time of channel formation for the data communication.

FIG. 2 is a diagram illustrating a PING message transmission interval in a wireless communication terminal supporting a plurality of accounts according to the related art.

Referring to FIG. 2, at PING message transmission, an MS using a plurality of accounts transmits a PING message for each of the plurality of accounts at a different interval. For example, in a case where the MS uses an account ‘A’ and an account ‘B’, the MS establishes an RRC connection with a mail server and transmits PING messages for both account ‘A’ and account ‘B’ according to each interval and, whenever transmitting each of the PING messages, forms a channel with a network. In the system of transmitting the PING messages for the plurality of accounts at different intervals as above, there is a problem where, because the number of times of transmission of the PING message of the MS increases as the number of accounts supported by the MS increases, the number of times of channel formation for data communication increases and thus an amount of battery consumption increases.

Therefore, a need exists for a method and an apparatus for determining a PING interval of an ActiveSync service in a wireless communication terminal.

### SUMMARY OF THE INVENTION

An aspect of the present invention is to address at least the above-mentioned problems and/or disadvantages and to provide at least the advantages below. Accordingly, an aspect of the present invention is to provide a method and an apparatus for determining a Packet INternet Groper (PING) interval of an ActiveSync service in a wireless communication terminal.

Another aspect of the present invention is to provide a method and an apparatus for determining a PING interval for a plurality of accounts in a wireless communication terminal supporting an ActiveSync protocol.

A further aspect of the present invention is to provide a method and an apparatus for transmitting PING messages of a plurality of accounts at the same interval in a wireless communication terminal supporting an ActiveSync protocol.

The above aspects are addressed by providing a method and an apparatus for determining a PING interval of an ActiveSync service in a wireless communication terminal.

According to an aspect of the present invention, a method for determining a PING interval in a wireless communication terminal supporting a plurality of accounts is provided. The method includes determining an initial PING interval of a first account among the plurality of accounts, and determining PING intervals of the remaining accounts, with the exception of the first account, as an integer multiple of the initial PING interval.

According to another aspect of the present invention, an apparatus for determining a PING interval in a wireless communication terminal supporting a plurality of accounts is provided. The apparatus includes a controller for determining an initial PING interval of a first account among the plurality of accounts, and for determining PING intervals of the remaining accounts, with the exception of the first account, as an integer multiple of the initial PING interval.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings in which:

FIG. 1 is a ladder diagram illustrating a Packet INternet Groper (PING) message transmission procedure of a wireless communication Mobile Station (MS) according to the related art;

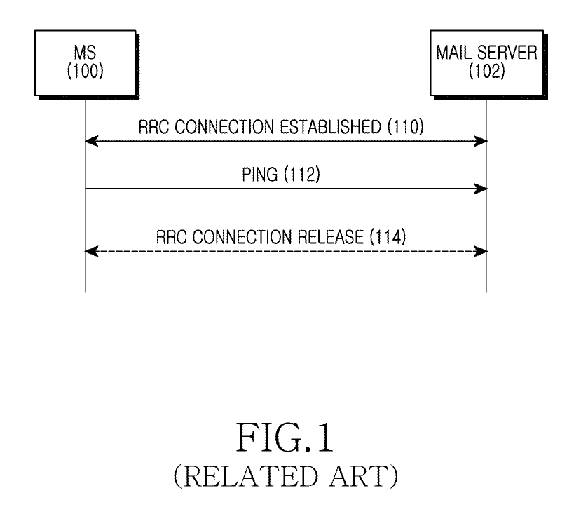

FIG. 2 is a diagram illustrating a PING message transmission interval in a wireless communication terminal supporting a plurality of accounts according to the related art;

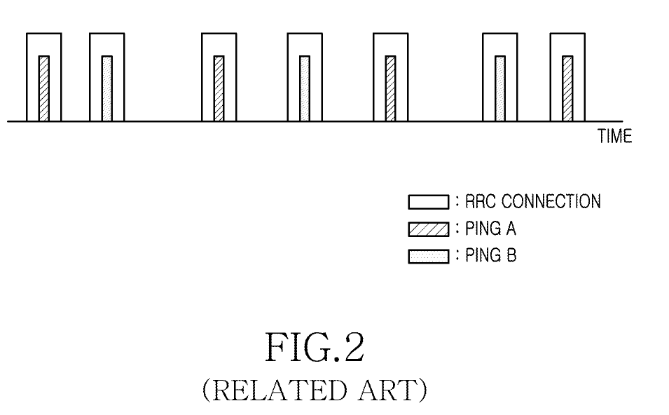

FIG. 3 is a diagram illustrating a PING message transmission interval in a wireless communication terminal supporting a plurality of accounts according to an exemplary embodiment of the present invention;

FIG. 4 is a block diagram illustrating a construction of a wireless communication terminal according to an exemplary embodiment of the present invention; and

FIG. 5 is a flowchart illustrating a procedure of determining a PING interval for a plurality of accounts in a wireless communication terminal according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The following description is made for a method and an apparatus for determining a Packet INternet Groper (PING) interval for a plurality of accounts in a wireless communication terminal supporting an ActiveSync protocol according to exemplary embodiments of the present invention. The following description is, for example, made for a case where the wireless communication terminal supports two accounts, and is identically applicable even to a case that the wireless communication terminal supports three or more accounts.

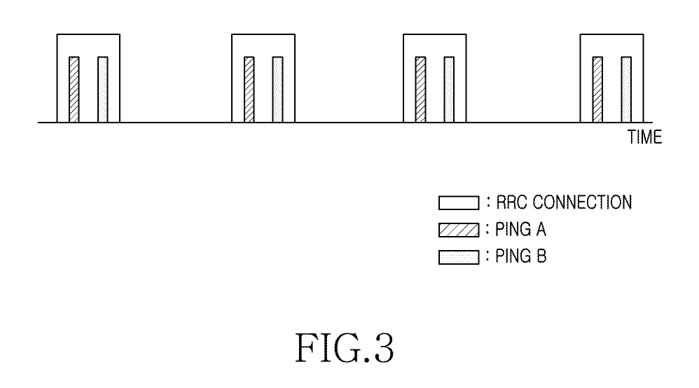

FIGS. 3 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly state otherwise. A set is defined as a non-empty set including at least one element.

FIG. 3 is a diagram illustrating a PING message transmission interval in a wireless communication terminal supporting a plurality of accounts according to an exemplary embodiment of the present invention.

Referring to FIG. 3, a case where a wireless communication terminal supports an account ‘A’ and an account ‘B’ according to an exemplary embodiment of the present invention is provided. The wireless communication terminal establishes a Radio Resource Control (RRC) connection with a mail server to transmit a PING message to the mail server. After the RRC connection is established, the wireless communication terminal either transmits a PING message of each of the account ‘A’ and the account ‘B’ at the same interval or transmits the PING message at the same time. More particularly, the wireless communication terminal either sets PING message transmission intervals of the respective account ‘A’ and account ‘B’ identical with each other, or sets the PING message transmission interval of the account ‘A’ to an integer multiple of the PING message transmission interval of the account ‘B’.

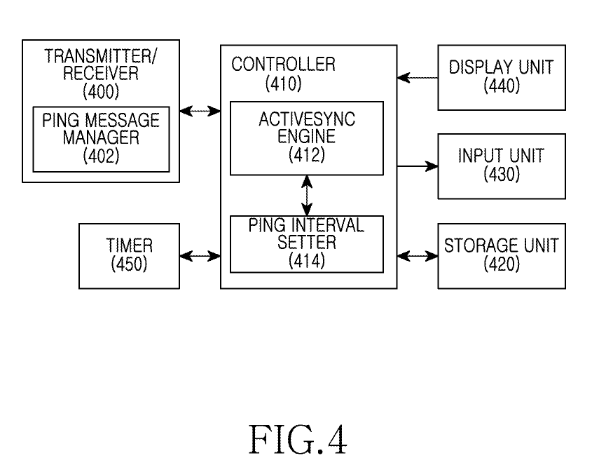

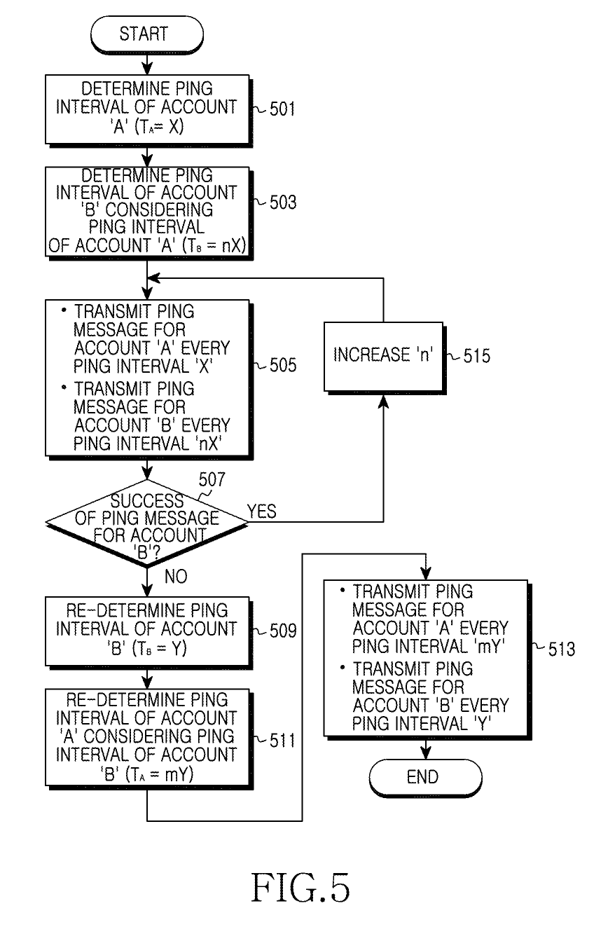

A system in which a wireless communication terminal supporting a plurality of accounts determines a PING interval and transmits a PING message is described below with reference to FIGS. 4 and 5.

FIG. 4 is a block diagram illustrating a construction of a wireless communication terminal according to an exemplary embodiment of the present invention.

Referring to FIG. 4, the wireless communication terminal includes a transmitter/receiver 400, a controller 410, a storage unit 420, an input unit 430, a display unit 440, and a timer 450. More particularly, according to an exemplary embodiment of the present invention, the transmitter/receiver 400 includes a PING message manager 402, and the controller 410 includes an ActiveSync engine 412 and a PING interval setter 414.

The transmitter/receiver 400 performs a function of transmitting/receiving and processing a wireless signal of data inputted/outputted through an antenna (not shown). More particularly, by including the PING message manager 402, the transmitter/receiver 400 establishes a channel for data communication with a network and transmits a PING message to a corresponding server through an ActiveSync protocol, under control of the controller 410.

The controller 410 controls and processes operations of the wireless communication terminal. By including the ActiveSync engine 412 and the PING interval setter 414 according to an exemplary embodiment of the present invention, the controller 410 sets a PING interval for a plurality of accounts, controls the timer 450, and transmits a PING message according to the set PING interval.

The ActiveSync engine 412 controls and processes an operation concerning an application making use of an ActiveSync protocol. The ActiveSync engine 412 controls and processes an operation for transmitting a PING request message including a PING interval that is set in the PING interval setter 414. The ActiveSync engine 412 detects reception or non-reception of a PING response message from a corresponding server during the set PING interval, determines a success or failure of transmission/reception of a PING message, and provides the result to the PING interval setter 414.

The PING interval setter 414 either maintains or changes a PING interval depending on a success or failure of transmission/reception of a PING message provided from the ActiveSync engine 412. More particularly, the PING interval setter 414 determines the optimum PING interval of an account ‘A’ among a plurality of accounts, and sets the optimum PING interval as a PING interval for the plurality of accounts. At this time, the optimum PING interval may be determined using various techniques, for example, a binary search technique. Here, in a case where transmission of the PING message for the plurality of accounts at the set PING interval is successful, the PING interval setter 414 may set the PING intervals of the remaining accounts, with the exception of the account ‘A’, to an integer multiple of the PING interval of the account ‘A’. For instance, in a case where the terminal (i.e., Mobile Station (MS)) supports an account ‘A’ and an account ‘B’, assuming that the optimum PING interval of the account ‘A’ is equal to ‘X’, the PING interval setter 414 may set a PING interval of the account ‘B’ to ‘X’, transmit a PING message, and, if a PING response message is successfully received in response to the PING message, set the PING interval of the account ‘B’ to ‘2X’.Assuming that the PING interval of the account ‘A’ is set to ‘2X’, the PING interval setter 414 will be able to set the PING interval of the account ‘B’ to ‘3X’, if transmission/reception of a PING message is successful.

Upon transmission/reception of the PING message for the plurality of accounts at the set PING interval as discussed above, in a where there is a failure to receive a PING response message for the account ‘B’ due to timeout of the timer 450, the PING interval setter 414 determines the optimum PING interval of the account ‘B’, and resets the determined optimum PING interval of the account ‘B’ as the PING interval for the plurality of accounts. That is, the PING interval setter 414 resets the PING interval determined for the account ‘B’ in place of the PING interval of the account ‘A’, as the PING interval for the plurality of accounts that the terminal supports. In addition, in a case where there is a successful transmission of the PING messages for the plurality of accounts at the reset PING interval, the PING interval setter 414 may set PING intervals of the remaining accounts, with the exception of the account ‘B’, to an integer multiple of the PING interval of the account ‘B’. For example, in a case where the terminal supports an account ‘A’ and an account ‘B’, assuming that the optimum PING interval of the account ‘B’ is equal to ‘Y’, the PING interval setter 414 may set a PING interval of the account ‘A’ to ‘Y’, transmit a PING message, and, if a PING response message is successfully received in response to the PING message, set the PING interval of the account ‘A’ to ‘2Y’.At this time, the PING interval (2Y) of the account ‘A’ should be set to a value less than or equal to the optimum PING interval (X) of the account ‘A’.

The storage unit 420 stores a variety of programs and data for general operation of the wireless communication terminal and, according to an exemplary embodiment of the present invention, stores a PING interval for a plurality of accounts.

The input unit 430 may include all or any of a plurality of numeral keys, character keys, and function keys, and provides key input data corresponding to a key pressed by a user to the controller 410. The display unit 440 can display any or all of state information generated during an operation of the wireless communication terminal, numerals, characters, a large amount of moving pictures and still pictures, and the like.

FIG. 5 is a flowchart illustrating a procedure of determining a PING interval for a plurality of accounts in a wireless communication terminal according to an exemplary embodiment of the present invention.

Referring to FIG. 5, a case of a terminal (i.e., MS) supporting an account ‘A’ and an account ‘B’ is described. In step 501, the terminal determines the optimum PING interval (T_{A}) of an account ‘A’ as ‘X’ (T_{A}=X). At this time, the optimum PING interval (T_{A}) may be determined using various techniques well known in the related art, for example, a binary search technique.

Thereafter, the terminal determines a PING interval (T_{B}) of an account ‘B’ considering the PING interval (T_{A}) of the account ‘A’ in step 503. More particularly, the terminal may set the PING interval (T_{B}) of the account ‘B’ to an integer multiple of the PING interval (T_{A}) of the account ‘A’. For example, assuming that the PING interval (T_{A}) of the account ‘A’ is equal to ‘X’, the terminal may set the PING interval (T_{B}) of the account ‘B’ to ‘nX’ (T_{B}=nX).

In step 505, the terminal transmits a PING message for the account ‘A’ at the optimum PING interval (X) determined in step 501, and transmits a PING message for the account ‘B’ at the PING interval (nX) determined in step 503. Here, the ‘n’ may be equal to ‘1’ in the case of initial transmission of the PING message for the account ‘B’.

Thereafter, the terminal determines if transmission/reception of the PING message for the account ‘B’ succeeds in step 507. More particularly, after transmitting the PING message for the account ‘B’, the terminal determines if a PING response message is received within a corresponding interval or if the PING response message is not received due to timeout. Here, the success or failure of transmission/reception of the PING message is determined only for the account ‘B’ without determining a success or failure of transmission/reception of a PING message for the account ‘A’ because the success of transmission/reception of the PING message for the account ‘A’ is naturally presumed from the fact that the PING interval of the account ‘A’ is set to the optimum PING interval in step 501.

If it is determined in step 507 that the transmission/reception of the PING message for the account ‘B’ succeeds, the terminal increases the ‘n’ value that determines the PING interval of the account ‘B’ in step 515, thereby increasing the PING interval of the account ‘B’. The terminal then returns to step 505 and again performs the subsequent steps. For example, assuming that the PING interval of the account ‘B’ is equal to ‘1X’ in the terminal, if the transmission/reception of the PING message for the account ‘B’ succeeds, the terminal increases the ‘n’ value, sets the PING interval of the account ‘B’ to ‘2X’, and transmits a PING message at the set PING interval (2X) of the account ‘B’.

In contrast, if it is determined in step 507 that the transmission/reception of the PING message for the account ‘B’ does not succeed, the terminal determines the optimum PING interval (T_{B}) of the account ‘B’ and re-determines the determined optimum PING interval (T_{B}) of the account ‘B’ as a new PING interval (Y) of the account ‘B’ (T_{B}=Y) in step 509.

In step 511, the terminal re-determines the PING interval of the account ‘A’ in consideration of the PING interval of the account ‘B’. That is, the terminal may set the PING interval of the account ‘A’ to an integer multiple of the PING interval of the account ‘B’. At this time, the re-determined PING interval of the account ‘A’ should be a value less than or equal to the PING interval (X) determined in step 501. For example, assuming that the PING interval (T_{B}) of the account ‘B’ is equal to ‘Y’, the PING interval (T_{A}) of the account ‘A’ may be set to ‘mY’. At this time, the ‘mY’ may be set to the greatest value among integer values less than or equal to ‘X’.

Thereafter, in step 513, the terminal transmits a PING message for the account ‘A’ at each PING interval (mY) re-determined in step 511, and transmits a PING message for the account ‘B’ at each PING interval (Y) re-determined in step 509.

Finally, the terminal terminates the procedure according to an exemplary embodiment of the present invention.

As described above, an exemplary embodiment of the present invention determines a PING interval for other accounts based on one account having the shortest PING interval among a plurality of accounts, thereby being capable of determining a PING interval for the plurality of accounts in a wireless communication terminal. That is, when transmitting a PING message for the account having the shortest PING interval, the terminal transmits PING messages of other accounts together and thus minimizes the number of times of establishing a channel with a network.

Also, exemplary embodiments of the present invention have an effect, by transmitting PING messages for a plurality of accounts at the same interval, of being capable of reducing the number of times of transmission of a PING message and reducing battery consumption in a wireless communication terminal supporting an ActiveSync protocol.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for determining a Packet INternet Groper (PING) interval in a wireless communication terminal supporting a plurality of accounts, the method comprising:
determining an initial PING interval of a first account among the plurality of accounts; and
determining PING intervals of the remaining accounts, with the exception of the first account, as an integer multiple of the initial PING interval.

2. The method of claim 1, further comprising:
transmitting PING messages of the remaining accounts at the PING interval having the integer multiple of the initial PING interval;
if a PING response message of a second account among the remaining accounts is not received, re-determining a PING interval of the second account; and
re-determining PING intervals of the remaining accounts, with the exception of the second account among the plurality of accounts, as an integer multiple of the PING interval of the second account.

3. The method of claim 2, wherein the re-determining of the PING intervals of the remaining accounts, with the exception of the second account, as the integer multiple of the PING interval of the second account comprises re-determining the PING interval of the first account among the remaining accounts, as a value less than or equal to the initial PING interval among values being the integer multiple of the PING interval of the second account.

4. The method of claim 2, further comprising, if the PING response message of the second account among the remaining accounts is received, increasing the PING interval of the second account determined as the integer multiple of the initial PING interval, by an integer multiple.

5. An apparatus for determining a Packet INternet Groper (PING) interval in a wireless communication terminal supporting a plurality of accounts, the apparatus comprising:
a controller for determining an initial PING interval of a first account among the plurality of accounts, and for determining PING intervals of the remaining accounts, with the exception of the first account, as an integer multiple of the initial PING interval.

6. The apparatus of claim 5, further comprising a transmitter/receiver for transmitting PING messages of the remaining accounts at the PING interval having the integer multiple of the initial PING interval,
wherein, if a PING response message of a second account among the remaining accounts is not received, the controller re-determines a PING interval of the second account, and re-determines PING intervals of the remaining accounts, with the exception of the second account among the plurality of accounts, as an integer multiple of the PING interval of the second account.

7. The apparatus of claim 6, wherein, when re-determining the PING intervals of the remaining accounts, with the exception of the second account as the integer multiple of the PING interval of the second account, the controller re-determines the PING interval of the first account as a value less than or equal to the initial PING interval among values being the integer multiple of the PING interval of the second account.

8. The apparatus of claim 6, wherein, if the PING response message of the second account among the remaining accounts is received, the controller increases the PING interval of the second account determined as the integer multiple of the initial PING interval, by an integer multiple.

9. The apparatus of claim 6, wherein the transmitter/receiver comprises a PING message manager for establishing a channel for data communication with a network.

10. The apparatus of claim 5, wherein the controller comprises an ActiveSync engine and a PING interval setter for setting a PING interval for the plurality of accounts and for controlling a timer of the wireless communication terminal prior to the transmission of a PING message transmitted according to the set PING interval.

11. The apparatus of claim 10, wherein the PING interval setter either maintains or changes a PING interval depending on a success or failure of transmission/reception of the PING message provided from the ActiveSync engine.

12. The apparatus of claim 10, wherein the PING interval setter determines the optimum PING interval using a binary search technique.
